(19) United States
(12) Patent Application Publication
(10) Pub. No.: US 2005/0011665 A1
(43) Pub. Date: Jan. 20, 2005

(54) Flexibly-stiffened electrical cable

(76) Inventors: Kevin J. Youngers, Greeley, CO (US); Rodney C. Harris, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 10/620,825

(22) Filed: Jul. 16, 2003

(51) Int. Cl. H01B 7/00

(52) U.S. Cl. 174/117 F; 174/117 A

(57) ABSTRACT

A flexibly-stiffened electrical cable comprises a flexible cable adapted to transmit electrical signals along a longitudinal direction. The cable is also nonlinearly formed in a lateral direction.

### TECHNICAL FIELD OF THE INVENTION

The present invention relates generally to the field of electronic equipment and, more particularly, to a flexibly-stiffened electrical cable.

### BACKGROUND OF THE INVENTION

Imaging devices, such as scanners, facsimile machines, and copy machines, generally comprise an image capturing device, such as a charge-coupled device, sensor array, or other image capturing equipment. The image capturing device is generally coupled to a carriage to enable movement of the image capturing device relative to an imaging surface such as a platen. An object disposed on the imaging surface is illuminated while the image capturing device moves relative to the object. The light reflected by the object is captured by the image capturing device and converted into electrical signals. A flexible electrical cable, such as a ribbon cable, is generally coupled to the image capturing device to accommodate movement of the image capturing device while transmitting the electrical signals to and/or from other processing devices.

Movement of the carriage and the associated image capturing device within the imaging system generally requires a relatively large amount of space within the imaging system. As a result, the electrical cable coupled to the image capturing device must be a sufficient length to accommodate the required movement. However, because the electrical cable must be flexible to accommodate the required movement, the electrical cable may become buckled, pinched or twisted, thereby damaging electrical conduits disposed within the electrical cable. Additionally, unanticipated buckling or crimping of the electrical cable may inhibit the required movement of the carriage and image capturing device.

### SUMMARY OF THE INVENTION

In accordance with one embodiment of the present invention, a flexibly-stiffened electrical cable comprises a flexible cable adapted to transmit electrical signals along a longitudinal direction. The cable is also nonlinearly formed in a lateral direction.

In accordance with another embodiment of the present invention, an imaging system comprises an image capturing device movable along a longitudinal direction and a flexible cable communicatively coupled to the image capturing device. The cable is nonlinearly formed in a lateral direction.

In accordance with yet another embodiment of the present invention, an imaging device comprises an image capturing device and a flexible electrical conduit coupled to the image capturing device. The conduit is adapted to accommodate movement of the image capturing device in a longitudinal direction. The imaging device also comprises a support member disposed relative to the conduit to prevent buckling of the conduit during the longitudinal movement of the image capturing device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an imaging system in which embodiments of the present invention may be used to advantage;

FIG. 2 is a diagram illustrating an embodiment of a flexibly-stiffened electrical cable in accordance with the present invention incorporated into the imaging system illustrated in FIG. 1;

FIGS. 3A and 3B are diagrams illustrating alternate embodiments of the flexibly-stiffened electrical cable illustrated in FIG. 2;

FIGS. 4A and 4B are diagrams illustrating additional embodiments of the flexibly-stiffened electrical cable illustrated in FIG. 2

FIG. 5 is a diagram illustrating another embodiment of an imaging system in accordance with the present invention; and

FIG. 6 is a diagram illustrating another embodiment of a flexibly-stiffened electrical cable in accordance with the present invention.

### DETAILED DESCRIPTION OF THE DRAWINGS

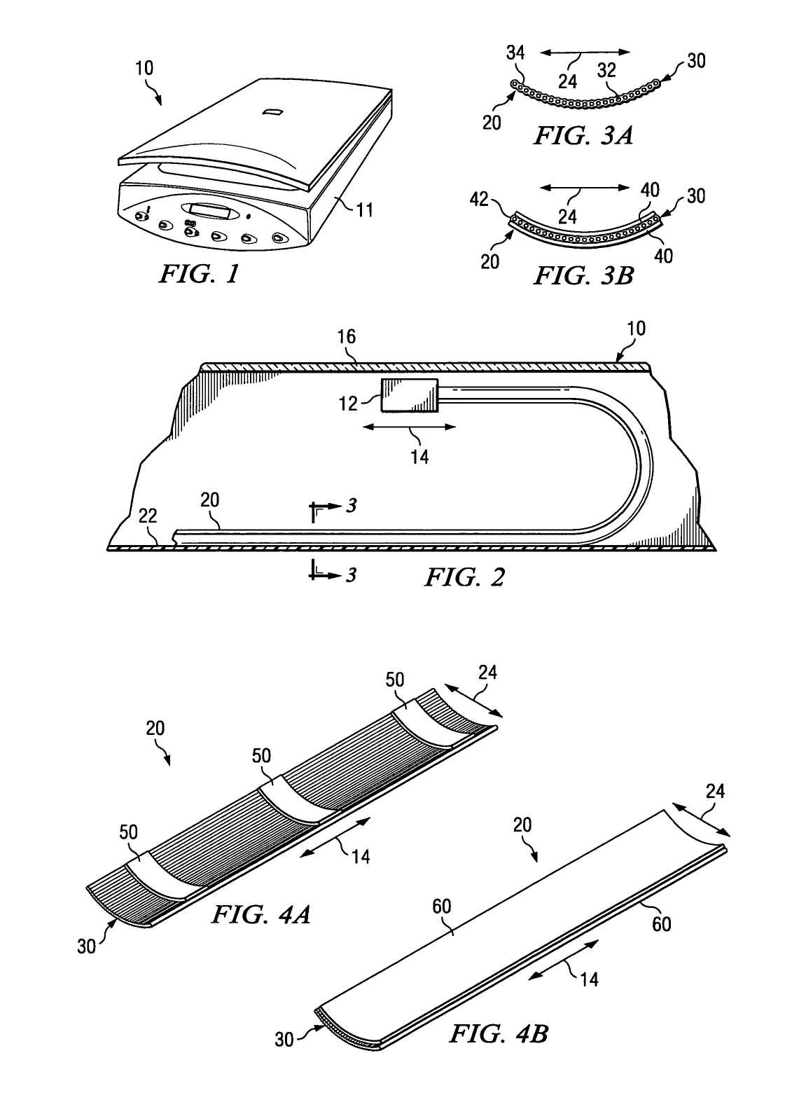

The preferred embodiments of the present invention and the advantages thereof are best understood by referring to FIGS. 1-6 of the drawings, like numerals being used for like and corresponding parts of the various drawings.

FIG. 1 is a diagram illustrating an imaging device 10 in which embodiments of the present invention may be used to advantage. In FIG. 1, imaging device 10 comprises a scanner or scanning device 11. However, it should be understood that imaging device 10 may alternatively or additionally comprise other types of devices for obtaining an image of an object including, but not limited to, a facsimile device or a copy machine. FIG. 2 is a side view illustrating an internal portion of imaging device 10 of FIG. 1. As illustrated in FIG. 2, imaging device 10 comprises an image capturing device 12 for obtaining or capturing an image of an object. Image capturing device 12 may comprise a charge-coupled device, contact image sensors, or other types of devices for capturing an image of an object. In operation, image capturing device 12 may be coupled to a carriage (not explicitly shown) for moving image capturing device 12 in a longitudinal direction, indicated generally at 14, relative to an object disposed on a platen 16 of imaging device 10. Thus, during illumination of the object, image capturing device 12 receives reflected light from the object and converts the reflected light to electrical signals.

As illustrated in FIG. 2, a flexibly-stiffened cable 20 is communicatively coupled to image capturing device 12 for transmitting electrical signals to and/or from image capturing device 12. Cable 20 is disposed within imaging device 10 to accommodate movement of image capturing device 12 along longitudinal direction 14. For example, as illustrated in FIG. 2, cable 20 is disposed along a lower internal surface 22 of imaging device 10 and extends longitudinally along surface 22 until extending upwardly in an arched or curved orientation and reversing direction until reaching image capturing device 12, thereby flexing inwardly or reversibly to accommodate longitudinal movement of device 12. Thus, cable 12 is configured from materials providing flexibility in the longitudinal direction 14 to accommodate movement of image capturing device 12 in the longitudinal direction 14. However, it should be understood that cable 20 may be otherwise disposed within imaging device 10 to accommodate movement of image capturing device 12.

FIGS. 3A and 3B are diagrams illustrating section views of alternate embodiments of cable 20 taken along the line 3-3 of FIG. 2. As illustrated in FIGS. 3A and 3B, cable 20 is formed having a nonlinear configuration in a lateral direction relative to direction 14, indicated generally at 24, to provide stiffness or rigidity in the lateral direction 24, thereby substantially reducing or preventing unwanted or unanticipated pinching, bunching, twisting or buckling of cable 20 in the longitudinal direction 14 resulting from movement of image capturing device 12.

Referring to FIG. 3A, cable 20 comprises a ribbon cable 30 having a plurality of adjacently disposed electrical conduits 32 for transmitting electrical signals to and/or from image capturing device 12. However, it should be understood that other types of cables having at least one electrical conduit 32 may be used. In FIG. 3A, cable 20 also comprises an outer jacket 34 formed of a rigid or semi-rigid material to maintain a lateral nonlinear configuration of cable 20. Thus, in operation, the nonlinear configuration of cable 20 provides rigidity or stiffness in the longitudinal direction of cable 20, thereby substantially reducing or eliminating the likelihood of cable 20 pinching, twisting, bunching, or buckling inwardly as a result of longitudinal movement of image capturing device 12.

Referring to FIG. 3B, the embodiment of cable 20 illustrated in FIG. 3B comprises stiffening support members 40 having a nonlinear configuration laterally coupled to opposite sides or surfaces of cable 20. For example, support members 40 are constructed from rigid or semi-rigid materials to maintain cable 20 in a nonlinear lateral configuration. Preferably, support members 40 are adhesively coupled to an outer sheathing 42 of ribbon cable 30; however, it should be understood that support members 40 may be otherwise secured to ribbon cable 30. In FIG. 3B, support members 40 are illustrated as being coupled to both or opposite sides of ribbon cable 30; however, it should be understood that a single support member 40 secured to only a single side or surface of ribbon cable 30 may also provide sufficient rigidity or stiffness in the longitudinal direction 14. In FIGS. 2 and 3A-3B, cable 20 is illustrated as being curved upwardly relative to surface 22 of imaging device 10 such that a convex surface of cable 20 is directed toward surface 22 so that a concave surface of cable 20 flexes inwardly toward itself in response to movement of image capturing device 12; however, it should be understood that the concave and convex surfaces of cable 20 may be reversed within imaging device 10 such that a concave surface of cable 20 is directed toward surface 22.

FIGS. 4A and 4B are diagrams illustrating additional embodiments of flexibly-stiffened cable 20. Referring to FIG. 4A, cable 20 comprises a plurality of intermittently disposed or spaced apart stiffening support members 50 coupled to ribbon cable 30. Each support member 50 comprises a rigid or semi-rigid construction to provide a nonlinear configuration in at least one direction. The nonlinear configuration of each support member 50 is laterally disposed relative to ribbon cable 30 to produce a laterally arched or curved cable 20. The support members 50 may also be constructed to remain flexible in the longitudinal direction. In FIG. 4A, support members 50 are illustrated as being secured to a single side or surface of ribbon cable 30; however, it should be understood that support members 50 may also be secured to both or opposite sides of ribbon cable 30. Further, in FIG. 4A, support members 50 are illustrated as being coupled to a concave surface portion of cable 30; however, it should be understood that support members 50 may also be coupled to a convex portion of cable 30. Support members 50 may be adhesively or otherwise secured to ribbon cable 30. Thus, in operation, the rigidity or stiffness provided by a laterally arched or curved cable 20 resists pinching, twisting, bunching, or inward buckling of cable 20 in the longitudinal direction.

In the embodiment illustrated in FIG. 4B, cable 20 comprises stiffening support members 60 coupled to opposite sides or surfaces of ribbon cable 30. Support members 60 each comprises a rigid or semi-rigid construction to provide a nonlinear configuration in at least one direction. The nonlinear configuration of each support member 60 is laterally disposed relative to ribbon cable 30 to produce a laterally arched or curved cable 20. The support members 60 may also be constructed to remain flexible in the longitudinal direction. In FIG. 4B, support members 60 are illustrated as being secured to opposite sides or surfaces of ribbon cable 30 and extend substantially a longitudinal length of ribbon cable 30. However, it should be understood that a single support member 60 may be coupled to only a single side or surface of ribbon cable 30 to provide sufficient rigidity or stiffness in the longitudinal direction 14 to reduce or substantially eliminate twisting, pinching, and/or inward bunching or buckling of ribbon cable 30 in the longitudinal direction 14. Additionally, the distance each support member 60 extends longitudinally along ribbon cable 30 may be varied to provide a desired level of stiffness or rigidity in the longitudinal direction 14. Further, in FIGS. 3A-3B and 4A-4B, the support members 40, 50 and 60 extend laterally to an entire lateral width of ribbon cable 30. However, it should be understood that support members 40, 50 and 60 may also provide sufficient rigidity or stiffness in the longitudinal direction 14 by extending only partially across a lateral width of ribbon cable 30.

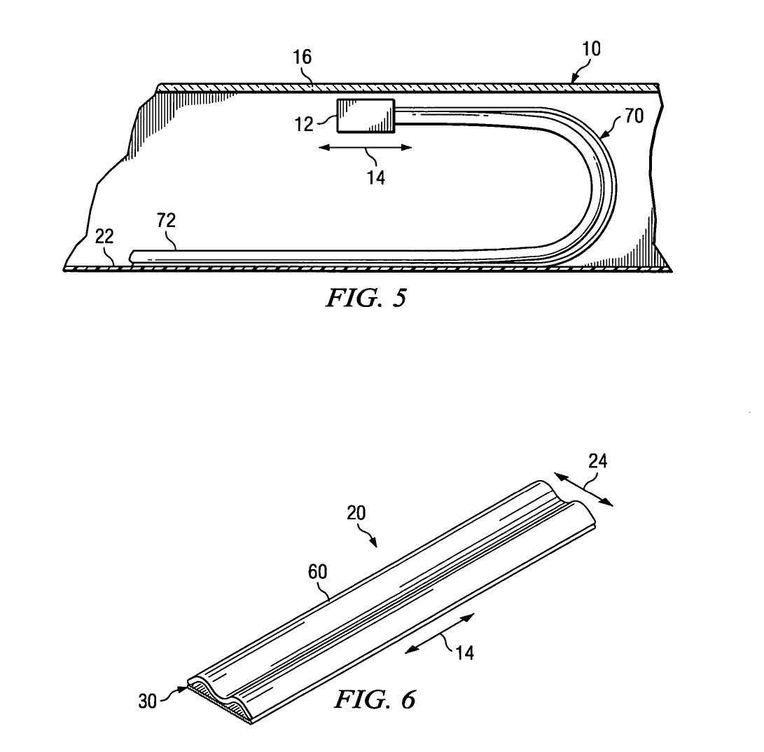

FIG. 5 is a diagram illustrating another embodiment of imaging device 10 in accordance with the present invention. In the illustrated embodiment, imaging device 10 comprises an electrical conduit 70 communicatively coupled to image capturing device 12. As described above, image capturing device 12 may comprise a charge-coupled device, contact image sensors, or other types of devices for capturing an image of an object and may be coupled to a carriage (not explicitly shown) for moving image capturing device 12 in a longitudinal direction, indicated generally at 14, relative to an object disposed on platen 16 of imaging device 10. Electrical conduit 70 may comprise a ribbon cable or other type of generally flexible member for communicating electrical signals to and/or from image capturing device 12.

As illustrated in FIG. 5, imaging device 10 also comprises a longitudinally stiffened support member 72 disposed relative to conduit 70 corresponding to an inward arched or curved position formed as a result of a reversing direction of conduit 70. Member 72 comprises a rigid or semi-rigid material and/or construction to form a lateral nonlinear configuration relative to conduit 70, as indicated generally by direction 24 illustrated in FIGS. 3A-3B, to prevent conduit 70 from twisting, pinching, bunching, or buckling inwardly during movement of image capturing device 12. For example, member 72 may be formed having an arcuate geometry, as illustrated in FIGS. 3A-3B, or may comprise other nonlinear configurations in the lateral direction relative to conduit 70. As illustrated in FIG. 5, member 72 may be disposed within imaging device 10 such that a space or gap is formed between member 72 and conduit 70, especially in an area of maximum bending of conduit 70 and/or member 72, to provide for bending relief between conduit 70 and member 72. Member 72 may be disposed within imaging device 10 in a variety of methods. For example, in one embodiment, member 72 may be coupled to opposite ends of conduit 70. In another embodiment, one end of member 72 may be coupled to image capturing device 12 or a carriage associated with image capturing device 12, and an opposite end of member 72 may be coupled to surface 22 near an end of conduit 70, thereby alleviating attaching member 72 directly to conduit 70. Accordingly, it should be understood that other methods of disposing member 72 within imaging device 10 relative to conduit 70 may be used to prevent an inward buckling or pinching of conduit 70.

Thus, in operation, in the embodiment illustrated in FIG. 5, member 72 is disposed corresponding to an internal bending radius of conduit 70 such that as image capturing device 12 moves in the longitudinal direction, member 72 maintains a generally similar arched movement path or position relative to and/or as conduit 70, thereby preventing conduit 70 from undesired bunching, pinching or buckling inwardly. As described above, member 72 may be formed having a variety of lateral nonlinear configurations. For example, member 72 may be formed and/or disposed within imaging device 10 having concave and/or convex surfaces facing away or toward surface 22.

FIG. 6 is a diagram illustrating another embodiment of cable 20 in accordance with the present invention. In the embodiment illustrated in FIG. 6, stiffening support member 60 comprises wave-shaped or “W”-shaped nonlinear configuration in the lateral direction, indicated generally at 24. Support member 60 may be disposed relative to ribbon cable 30 as described above in connection with FIG. 5 such that ribbon cable 30 remains in a flat position against surface 22 until bending upwardly and in a reverse direction to accommodate longitudinal movement of image capturing device 12, indicated generally at 14. Thus, members 40, 50, 60 and 72 may be formed having a variety of nonlinear configurations and may be located relative to an inward bending side of cable 30 or conduit 70 to prevent inwardly pinching or buckling of cable 30 or conduit 70. Additionally, various combinations of members 40, 50, 60 and/or 72 may be used on a particular electrical cable to provide a desired nonlinear stiffness for the electrical cable. For example, in one embodiment, members 50 may be disposed along one side of an electrical cable and member 60 may be disposed on an opposite side of the electrical cable. Thus, it should be understood that a variety of combinations and quantities of members 40, 50, 60 and/or 72 may be used to obtain a desired electrical cable configuration.

1. A flexibly-stiffened electrical cable, comprising:
a flexible cable adapted to transmit electrical signals along a longitudinal direction, the cable nonlinearly formed in a lateral direction.

2. The electrical cable of claim 1, wherein the cable comprises a ribbon cable.

3. The electrical cable of claim 1, further comprising at least one nonlinear stiffening support member laterally secured to the cable.

4. The electrical cable of claim 1, further comprising a nonlinear stiffening support member coupled to each side of the cable.

5. The electrical cable of claim 1, wherein the cable is disposed in at least one of a scanner, a copy machine, and a printer.

6. The electrical cable of claim 1, further comprising a plurality of intermittently disposed nonlinear stiffening support members laterally coupled to the cable.

7. The electrical cable of claim 1, further comprising a nonlinear stiffening support member adhesively secured to the cable in the lateral direction.

8. The electrical cable of claim 1, wherein the cable is molded having a nonlinear configuration in the lateral direction.

9. The electrical cable of claim 1, further comprising a nonlinear stiffening support member coupled to the cable in the lateral direction, the stiffening support member flexible in the longitudinal direction.

10. The electrical cable of claim 1, further comprising a nonlinear stiffening support member coupled to opposite ends of the cable.

11. An imaging device, comprising:
an image capturing device movable along a longitudinal direction; and
a flexible cable communicatively coupled to the image capturing device, the cable nonlinearly formed in a lateral direction.

12. The device of claim 11, wherein the cable comprises a ribbon cable.

13. The device of claim 11, wherein the cable comprises at least one nonlinear stiffening support member laterally secured thereto.

14. The device of claim 11, wherein the cable comprises a plurality of oppositely disposed nonlinear stiffening support members.

15. The device of claim 11, wherein the imaging system comprises at least one of a scanner, a copy machine, and a printer.

16. The device of claim 11, wherein the cable comprises a plurality of intermittently and laterally disposed nonlinear stiffening support members.

17. The device of claim 11, wherein the cable comprises a nonlinear stiffening support member adhesively secured thereto in the lateral direction.

18. The device of claim 11, wherein the cable is molded having a nonlinear configuration in the lateral direction.

19. The device of claim 11, wherein the cable comprises a nonlinear stiffening support member laterally coupled thereto, the stiffening support member flexible in the longitudinal direction.

20. A linearly stiffened electrical cable, comprising:
flexible means for transmitting electrical signals along a longitudinal direction; and
means for nonlinearly forming the flexible means for transmitting the electrical signals in a lateral direction.

21. The cable of claim 20, wherein the means for stiffening comprises at least one nonlinear stiffening support means laterally secured to the flexible means for transmitting the electrical signals.

22. The cable of claim 20, wherein the means for stiffening comprises a plurality of intermittently and laterally disposed nonlinear stiffening support means coupled to the flexible means for transmitting the electrical signals.

23. The cable of claim 20, wherein the means for stiffening comprises a semi-rigid outer jacket disposed about the flexible means for transmitting the electrical signals.

24. The cable of claim 20, wherein the means for stiffening comprises a nonlinear stiffening support means adhesively secured in the lateral direction to the flexible means for transmitting the electrical signals.

25. An imaging device, comprising
an image capturing device;
a flexible electrical conduit coupled to the image capturing device, the conduit adapted to accommodate movement of the image capturing device in a longitudinal direction; and
a support member disposed relative to the conduit to prevent buckling of the conduit during the longitudinal movement of the image capturing device.

26. The imaging device of claim 25, wherein the support member comprises a nonlinearly formed support member.

27. The imaging device of claim 25, wherein the support member comprises a nonlinear configuration laterally disposed relative to the electrical conduit.

28. The imaging device of claim 25, wherein the support member is disposed corresponding to an internal bend radius of the electrical conduit.

29. The imaging device of claim 25, wherein the support member is disposed relative to the electrical conduit to provide bend relief between the support member and the electrical conduit.
